(19) United States
(12) Patent Application Publication
(10) Pub. No.: US 2007/0018353 A1
(43) Pub. Date: Jan. 25, 2007

(54) Process and apparatus for the production of articles made of plastic material with at least one overmoulded component

(75) Inventors: Maurizio Bazzo, Oderzo (Treviso) (IT); Peter Dal Bo, Vittorio Veneto (Treviso) (IT)

Correspondence Address: HESLIN ROTHENBERG FARLEY & MESITI PC, 5 COLUMBIA CIRCLE, ALBANY, NY, 12203, US

(73) Assignee: INGLASS S.p.A., San Polo di Piave (Treviso) (IT)

(21) Appl. No.: 11/491,373

(22) Filed: Jul. 21, 2006

(30) Foreign Application Priority Data
Jul. 22, 2005 (IT) TO2005A000505

(51) Int. Cl. B29C 45/00

(52) U.S. Cl. 264/255; 264/328.7; 264/328.8; 425/112

(57) ABSTRACT

Described herein is a process and apparatus for the production of an article made of moulded plastic material including a first component formed in a first injection step and possible compression step, and at least one second component overmoulded on said first component in a second injection step and possible compression step. The moulding is carried out in a single station defined by a mould and a countermould and, prior to forming the first component, recesses for formation of elements of attachment and/or reinforcement integrally with the second component are closed or modified.

### FIELD OF THE INVENTION

The present invention relates to the production of articles made of moulded plastic material in general, particularly (but not exclusively) plates, with at least one overmoulded component.

The plates to which the invention finds particular (but, as has been said, not exclusive) application may be transparent or not, and also the elements overmoulded thereon may be transparent or not, made of the same material as the plates or of a different material. Such elements may be overmoulded in peripheral areas of the plate, for example along its peripheral edge, or else in different areas.

In any case, the invention is particularly aimed at the production of articles with aesthetic characteristics of high quality, for which the surface in view is conventionally referred to as “class A”.

### STATE OF THE PRIOR ART

Traditional techniques for overmoulding articles of not particularly high quality, or in any case of aesthetic characteristics that are not so high as the ones to which the invention particularly relates, envisage a first injection step to form the first component within a cavity defined between a mould and a countermould, a geometrical variation of the cavity by means of internal movements, and then a second step of injection of the second component for overmoulding thereof on the first component. These operations can be carried out in a single station, without any particular difficulty.

In the case of articles with aesthetic characteristics of high quality and also with relatively large dimensions, such as for example plates for producing transparent panels in the automotive sector, the methodology currently used envisages a first step of injection of the material that is to form the first component within a cavity defined between a mould and a countermould, to which there can be possibly associated a step of compression or else of expansion-compression fundamentally for the purpose of reducing the residual internal stresses of the injected material. This first step is carried out traditionally in a first station: the moulding cavity is then opened, and the countermould with the first component is transferred—generally via rotation about a vertical axis or else a horizontal axis—to a second station, where a second mould delimits a new cavity for injection (said injection being possibly also combined with a step of compression or expansion-compression) of the material for overmoulding the second component on the first. A typical example of a moulding apparatus of this type is represented by presses of the “stack-mould” type with double countermould rotating about a vertical axis, as generally described in the document No. DE-A-10217584.

Peculiar solutions for improving the moulding process implemented with apparatus of this sort, in order to obtain items even of large dimensions with the maximum quality possible, are described and illustrated in the Italian patent applications Nos. TO2004A000696, TO2004A000697, TO2004A000698, TO2004A000699, TO2004A00700, TO2004A000701, TO2004A000702, TO2004A000703, TO2004A000716 and TO2004A000813, all filed in the name of the present applicant and not published at the date of priority of the present application.

The overmoulding obtained with technologies of this sort enables particularly robust internal fixing and reinforcement elements to be obtained for the article overmoulded, without altering the aesthetic characteristics of the outer surface of the article itself. These technologies envisage, as has been said, moulding of the bi-component articles with rotation of the countermould and consequently always involve a displacement: the first component moulded in the first station is, as has been said, displaced into a second station for moulding of the second component. This involves a considerable complexity of the moulding apparatus and of the corresponding controls, particularly in the case where one or both of the injection steps are co-ordinated with a step of compression or of expansion-compression, as well as involving large overall dimensions of the apparatus.

### SUMMARY OF THE INVENTION

The purpose of the present invention is to provide a process for the production of bi-component (or generally multi-component) articles made of plastic material even of large dimensions and in any case of high aesthetic quality, by means of which the need to rotate the countermould, subsequent to formation of the first component, to proceed to overmoulding of the second component by means of a second mould is avoided.

According to the invention, this purpose is achieved thanks to the fact that a process as defined in the preamble of claim 1 is principally characterized in that it is carried out in a single station defined by said mould and said countermould, and in that to form said first component said at least one recess is modified.

The modification, which can occur before or during formation of the first component, consists preferably in a partial or total closing of said at least one recess.

The geometrical variation of the cavity can include conveniently a step of recession between said mould and said countermould, obtaining in this way a thickness of the final mould that is different between the first step and the second step.

Furthermore, the two injection steps may be steps of just injection, or else one or the other or both of them can be combined with a step of compression or of expansion-compression.

Further characteristics and alternative embodiments of the process are defined in the subordinate claims 2-11.

The subject of the invention is also an apparatus for implementation of the process, defined mainly in claim 12 and in its secondary characteristics in claims 13-20 subordinate thereto.

### BRIEF DESCRIPTION OF THE DRAWINGS

The invention will now be described in detail with reference to the annexed plate of drawings, in which:

FIG. 1 is a schematic dorsal elevation of a bi-component plate of plastic material that can be obtained using the process according to the invention;

FIG. 2 is a cross-sectional view according to the line II-II of FIG. 1;

FIG. 3 is a front elevation of the plate of FIG. 1;

FIG. 4 is a partially sectioned schematic view of a first embodiment of an apparatus for implementation of the process according to the invention, represented in a first operating step;

FIGS. 5, 6 and 7 are three views similar to those of FIG. 4 that illustrate the apparatus in respective successive operating steps;

FIGS. 8 and 9 show at an enlarged scale a detail of the apparatus of FIGS. 4 to 7;

FIGS. 10 and 11 are schematic illustrations of a variant of the apparatus in the same two successive operating steps; and

FIGS. 12 and 13 are schematic illustrations of a further variant of the apparatus in the same two successive operating steps.

### DETAILED DESCRIPTION OF EMBODIMENTS OF THE INVENTION

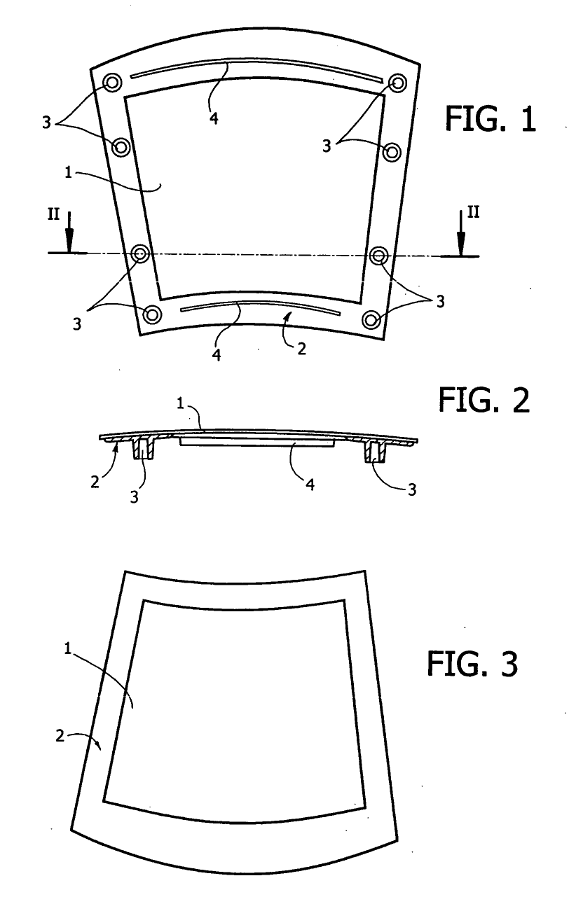

With reference to the drawings, FIGS. 1 to 3 are schematic illustrations of an example of a bi-component article made of plastic material obtained with the process and the apparatus according to the invention. It should be noted that the article described hereinafter is illustrated purely by way of non-limiting example, and that the invention is applicable to articles of different shapes and characteristics including in any case a first component and at least one second component overmoulded on the first, the surface of which exposed in use to view has aesthetic characteristics of high quality. The article represented in FIGS. 1 to 3 consists of a sunroof for use in the automotive sector constituted by a plate 1 that is normally (but not necessarily) transparent, typically made of polycarbonate, overmoulded on the dorsal face of which is a perimetral frame 2 of a material that is normally (but not necessarily) non-transparent, for example black in colour, formed with fixing appendages 3 and with possible stiffening projections or ribbings 4.

In what follows the transparent plate 1 and the perimetral frame 2 will be for convenience designated, respectively, as external component 1 and internal component 2.

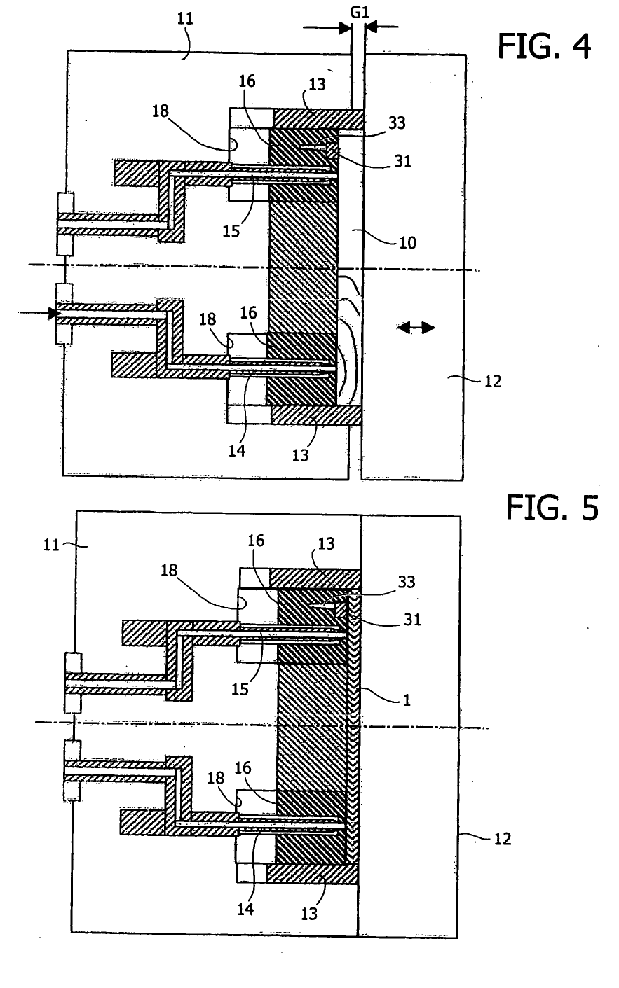

FIG. 4 is a schematic illustration of a possible embodiment of the apparatus for producing an article generally in accordance with FIGS. 1 to 3. The more general inventive idea underlying the invention is that of overmoulding the internal component 2 on the external component 1 in a single station, without any need for rotation of the mould about a vertical axis or horizontal axis to bring the previously moulded external component 1 into a subsequent station for overmoulding of the internal component 2, using particular solutions for producing the fixing appendages 3 and/or stiffening ribbings 4 integrally with the internal component 2, this in the case where forming of the external component 1 and/or forming by overmoulding of the internal component 2 use methodologies of simple injection, or else of compression or else of expansion-compression combined with injection of the plastic material. Suppression of a second station for overmoulding the internal component 2, as well as elimination of the need to transfer the external component 1 from a first station to a second station, enable drastic simplification of the structure of the moulding apparatus and elimination of any problem connected to the coupling between the mould bearing the external component 1 and a second countermould for closing the cavity comprised between them and overmoulding of the internal component 2.

In FIG. 4, the reference number 10 designates the moulding cavity comprised between a mould 12 and a countermould 11, which are translatable with respect to one another. In the case of the example illustrated, the mould 12 can be brought up to and moved away from the countermould 11, which is instead stationary. Also more than one cavity 10 may be provided.

The cavity 10 is delimited in a generally conventional way by mobile closing ring nuts 13, for example carried by the countermould 11, which is equipped with an injection apparatus, which is also generally conventional, comprising one or more injectors 14 for injection within the cavity 10 of the plastic material that is to constitute the external component 1, and one or more injectors 15 for the subsequent injection of the plastic material that is to form the internal component 2.

The configuration of the cavity 10 is geometrically modifiable either as a result of a greater or smaller approach between the mould 12 and the countermould 11 in the conditions of closing of the cavity 10 corresponding to the two successive injection steps or possibly via displacement within it of at least one mobile part, for example carried by the countermould 11. In the case now described, a single annular mobile part 16 is provided, which can be displaced, via an actuator (not illustrated), for example a fluid actuator or actuator of another type, between a position set in and a position extracted with respect to a front recess 18 formed in the countermould 11.

The cycle of operation of the apparatus thus described for the production of the article according to FIGS. 1 to 3 is described in what follows.

Since, as has been said, the external component 1 is in this case transparent, it will have to be formed first given that otherwise, i.e., if the internal component 2 were initially formed, its colouring could spread in areas that must instead be necessarily kept perfectly transparent and clear: this would irremediably damage the quality and the aesthetic appearance of the product. Taking into account the dimensions and the high aesthetic characteristics that must be obtained by the production of the article according to FIGS. 1 to 3, each step of injection of the material of one and the other component 1, 2 will be normally combined with a compression step (or possibly a step of expansion-compression). It should, however, be pointed out that, in order to produce articles of less noble quality and characteristics or of modest dimensions, forming of one and/or of the other component may be obtained also by means of simple injection.

In the initial step, represented in FIG. 4, the mould 12 is opened and set at a distance from the countermould 11 by an amount G1 that will then be used for carrying out the compression step. Alternatively, it will be kept closed in the case of just injection, as well as in the case of expansion-compression, and will then be opened by the same amount during the injection step.

One or more injectors 14, as has been said, for injection within the cavity 10 of the material that is to constitute the external component 1, possibly controlled in sequence, are positioned in an area that will subsequently be—as will be seen—coated with the second component 2. In this way, the witness marks of the points of injection of the first component 1 will then be hidden on the outside.

The mobile part 16 is advanced in the recess 18, in the way represented in FIG. 4, and the mobile ring nuts 13 for sealed closing of the cavity 10 are activated to remain in contact with the mould 12. The injectors 14 are then activated so as to introduce the plastic material of the external component 1 within the cavity 10, whilst the injectors 15 remain inactive.

Following upon or in the course of the injection step, the mould 12 is re-closed against the countermould 11, carrying out the compression of the material injected within the cavity 10. The closing ring nuts 13 of the cavity 10, albeit remaining pushed against the mould 12, retract until this is completely closed against the countermould 11.

After an appropriate time for cooling, the external component 1 is formed.

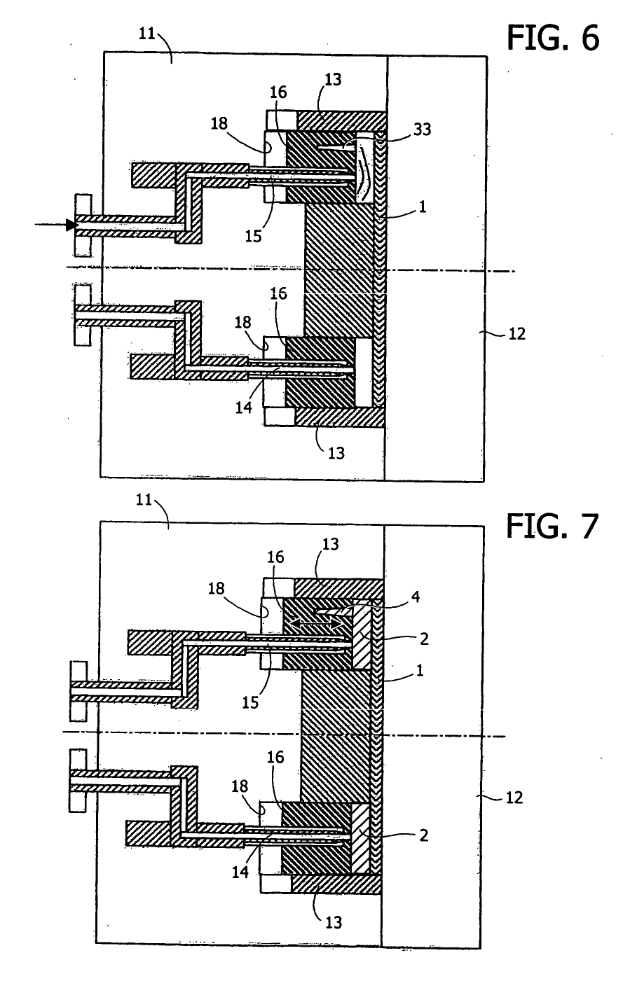

The subsequent step, represented in FIG. 6, envisages first of all recession of the mobile part 16 with respect to the recess 18, whilst the mould 12 remains closed against the countermould 11. Alternatively, it can open by an amount corresponding to the sum of the final thickness of the internal component 2 and of the opening desired for the possible compression. This opening could also be made after activation of the injectors 15 for injection of the material of the internal component 2 within the cavity 10, in the case where the technique of expansion-compression is used.

In this way the previously moulded external component 1 moves away from the mould 12, and the injection of the material of the internal component 2 within the cavity 10 is performed by means of activation of the injectors 15, whilst the injectors 14 remain inactive.

At the end of closing of the mould 12, the configuration is the one represented in FIG. 7: once an appropriate time for cooling has elapsed, the finished piece, with the internal component 2 overmoulded along the perimeter of the external component 1, can be extracted with altogether conventional modalities, via extraction devices, which are not illustrated in so far as they are within the reach of the person skilled in the branch.

Forming of the article is carried out in a single station, without any need for moving the first moulded component towards a second station for moulding the second component. The overall dimensions and the costs of the moulding apparatus are in this way appreciably reduced.

In the case where the injection steps are combined with a compression, it is possible to use either totally or in part solutions described and illustrated in the prior Italian patent applications cited previously Nos. TO2004A000696, TO2004A000697, TO2004A000698, TO2004A000699, TO2004A00700, TO2004A000701, TO2004A000702, TO2004A000703, TO2004A000716 and TO2004A000813, the contents of which must be understood as being incorporated herein for immediate reference.

The methodology consisting in injecting first of all the transparent component 1 could theoretically lead to problems as regards construction of the fixing elements 3 and/or stiffening elements 4 at the moment of the subsequent forming of the internal component 2. According to the invention, this problem is solved brilliantly, by modifying and more in particular by closing either partially or totally, before or during moulding of the transparent component 1, the recesses of the countermould 11 provided for formation of said fixing elements 3 and/or stiffening elements 4. In general terms, said closing can be obtained with mobile parts, for example hydraulically actuated ones, or with the aid of closing elements or else again of film.

In the case represented with reference to FIGS. 4 to 7, the mobile part 16 is formed with a front recess 33 within which, during the step of injection and possible compression of the second component 2, a stiffening element 4 is formed integral with said internal component 2. The invention envisages closing the recess 33, as well as possible further recesses of the countermould 11 provided for formation of additional fixing elements 3 and/or stiffening elements 4, using preferably mobile parts, which can be displaced via actuators.

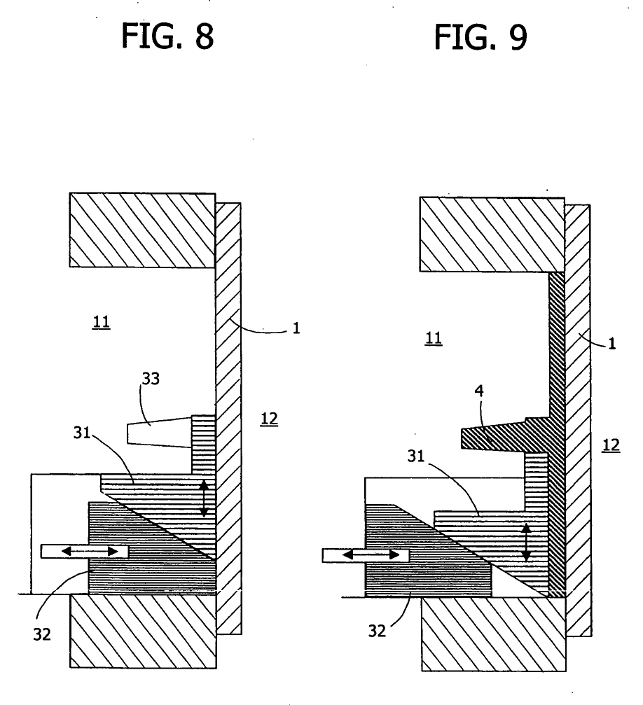

FIGS. 8 and 9 represent at an enlarged scale the mobile part 31 for closing the recess 33, respectively in the closing condition and in the opening condition. The mobile part 31, moved for example by a wedge 32, which is in turn actuated by a motor-driven actuator (not illustrated), operates so as to close the recess 33 of the mobile part 16 of the countermould 11 during moulding of the external component 1 (FIGS. 4, 5 and 8), and re-open said recess 33 to enable introduction of the material of the internal component 2 when this is overmoulded on the external component 1, so as to form the stiffening elements 4 (FIGS. 6, 7 and 9). This solution enables a partial extraction of the stiffening elements 4 to be obtained without any problem.

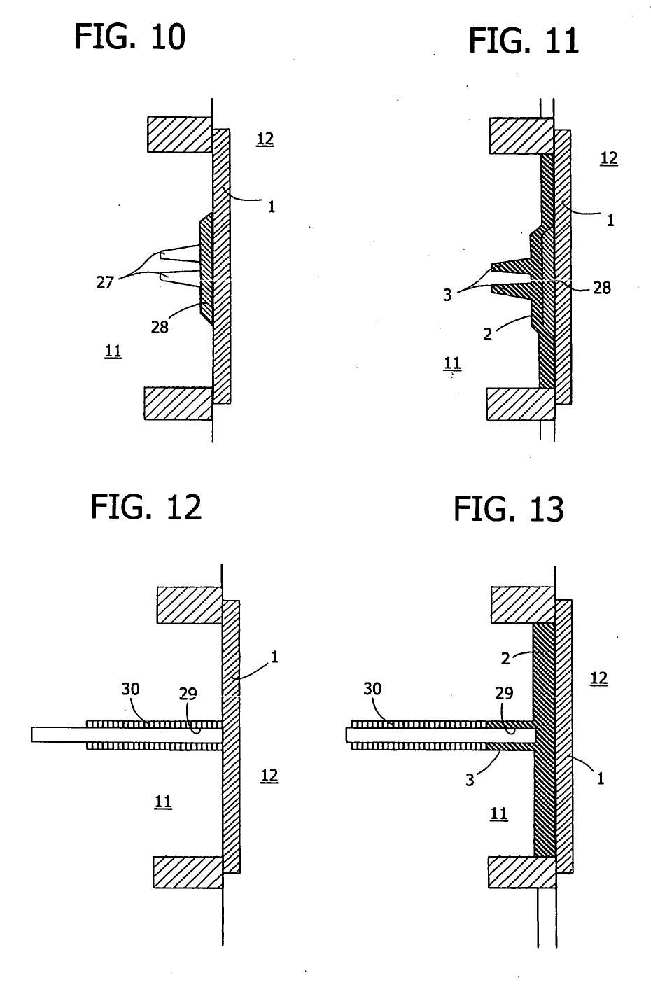

Further alternative modalities to modify, or rather, close recesses of the countermould 12, designed for example to form attachment elements 3 of the internal component 2, are represented in FIGS. 10, 11 and 12, 13, respectively.

In the case of FIGS. 10 and 11, closing of recesses 27 is obtained via a covering element 28. Said covering element 28 can be constituted by a thin film or else—as in the case represented precisely in FIGS. 10 and 11—by an insert having a certain thickness and thus sufficiently robust to withstand the pressure of injection and possible compression of the external component 1. The covering element 28 is consolidated against the internal surface of the external component 1 during moulding thereof (FIG. 10) and then, following upon injection of the internal component 2, it is englobed therein, whilst the injected material fills the recesses 27 to form the attachment element 3 (FIG. 11). It is convenient for the covering element 28 to be chamfered to favour sliding of the material of the internal component 2, or else for its thickness to be substantially smaller than what is envisaged for said internal component 2.

Alternatively, the covering element 28 could be already pre-formed with the attachment element 3 and introduced as insert within the cavity 10 and then be englobed in the internal component 2. In this case the covering element 28 would be more complex, but could also be made of metal or of a material with high resistance, and also present more complex shapes.

A further alternative to obtain closing of the recesses corresponding to the attachment elements 3 and/or stiffening elements 4 during moulding of the external component 1 can consist in the use of an appropriately shaped extractor, as illustrated in FIGS. 12 and 13. In this case, for example, a recess 29 for formation of an attachment element 3 will present a tubular conformation corresponding to the one of the tubular extractor 30, which will be kept in an advanced position flush with the cavity 10 during moulding of the external component 1 (FIG. 12) and will then be partially retracted so as to free a portion of the recess 29, which will then be occupied by the material of the internal component 2 at the moment of moulding thereof (FIG. 13). Of course, in the retracted position illustrated in FIG. 33, the tubular extractor 30 will have to be pre-arranged so as not to retract under the thrust of the pressure of injection and subsequent possible compression of the material of the external component 1.

All of the lines of joining or minor defects due to the presence of radiusing, errors of alignment etc., will in this case be coated with the material of the internal component 2, and will not be visible from outside even in the case where the external component 1 is transparent.

With the solutions described above, the possible fixing elements 3 and the possible strengthening elements 4 of the internal component 2 may be obtained with substantial thicknesses and in any case ones greater than those obtained with conventional injection systems, thus ensuring a greater sturdiness.

It should be noted that the techniques of closing described above with reference to FIGS. 8 to 13 can find advantageous generalized application also to cases in which the bicomponent or pluricomponent article is obtained just by injection, or else by means of injection-compression or else again via injection-expansion-compression, also totally or partially with the methodologies described and illustrated in the Italian patent applications already cited previously.

Finally, it should be pointed out that the examples described with reference to the drawings are just some of an infinite multiplicity of possible embodiments of the apparatus for implementation of the process according to the invention. Listed hereinafter are some of the possible variant embodiments that may be envisaged in the framework of the invention.

1. The moulded item may not only be plane, but also curved and with more or less complex shapes.

2. The injection can be performed not only directly but also with conventional technologies of the film type or tunnel type, etc., and also with sequential modalities.

3. The mobile ring nuts 13 associated to the countermould 11 for keeping the cavity 10 closed can possibly be positioned on the mould 12, in the case where this were constructionally more convenient or more expedient in proportion to the conformation of the article to be moulded.

4. The injectors 14 and 15 for injection of the material of the external component 1 and of the material of the internal component 2 can be positioned in a way different from what is represented in FIGS. 4 to 7.

5. The devices for actuation of the mobile parts 31, 32 previously described have not been illustrated nor described in detail in so far as they may indifferently be of an electrical, mechanical, hydraulic, or pneumatic type, in any case within the reach of the person skilled in the branch.

6. Nor has the extraction part of the apparatus been illustrated and described in detail, in so far as it can be obtained according to traditional systems and without any constraint.

7. Even though in FIGS. 4 to 7 only one injector 14 for the external component 1 and one injector 15 for the internal component 2 have been illustrated, there may be provided for both of the components a multiple-point injection, possibly controlled in sequence as in the case of the already cited Italian patent application No. TO2004A000700.

8. Even though, in the foregoing description, it is envisaged to carry out both moulding of the first component and overmoulding of the second component by means of injection-compression, application of the compression step for one of the components only or else application of the technique of injection with expansion-compression for one or both of the components is possible and foreseeable in the framework of the invention, and even in the case where no injection-compression step is envisaged, it is possible to exploit advantageously opening of the mould by an amount equal to the thickness to be moulded; opening can be obtained using the press or else by elements operatively connected to the mould itself.

9. The plastic materials used for the first and second components (as well as for possible further components overmoulded on the first component) may be extremely varied, transparent or not, and also different compositions may be used in the case where some areas of the article are to be painted, decorated or coated with a film using an IMD technique and the like.

10. It is also possible to contemplate the use of gas and/or liquid for emptying out the hollow sections.

11. As has already been repeatedly clarified, the external component 1 is not necessarily transparent.

12. The recesses for formation of the elements of attachment and/or reinforcement 3, 4 of the second component 2 could be, instead of completely closed prior to or during moulding of the first component, simply modified in an appropriate way according to the moulding requirements, for example via just a partial closing thereof.

Of course, the details of construction of the apparatus and the modalities of embodiment of the process may vary widely with respect to what is described and illustrated herein, without thereby departing from the scope of the present invention as defined in the ensuing claims.

1. A process for the production of an article made of moulded plastic material with a first component and at least one second component overmoulded on the first component, including:
a first injection step to form said first component within a cavity defined between a mould and a countermould;
a geometrical variation of said cavity; and then
a second step of injection of said second component for overmoulding thereof on the first component, in which said second component is made with at least one projecting element of at least one of attachment and reinforcement formed within at least one corresponding recess of said countermould,
said process being carried out in a single station defined by said mould and said countermould, and wherein said at least one recess is modified to form said first component.

2. The process according to claim 1, wherein the step of modifying said at least one recess comprises at least partial closing thereof.

3. The process according to claim 2, wherein said recess is closed and then re-opened by mobile parts.

4. The process according to claim 2, wherein said recess is closed by a covering element that adheres to said first component and is then englobed in said second component.

5. The process according to claim 2, wherein said recess is closed by a covering film.

6. The process according to claim 2, wherein said recess is closed and then re-opened using extractor means.

7. The process according to claim 1, wherein said geometrical variation of the cavity includes a step of moving away said mould relative to said countermould.

8. The process according to claim 1, wherein said geometrical variation of the cavity includes the displacement within it of at least one mobile part of said countermould.

9. The process according to claim 1, wherein at least one of said first and second injection steps includes a compression step.

10. The process according to claim 1, wherein at least one of said first and second injection steps includes a step of expansion and subsequent compression.

11. The process according to claim 1, wherein said first component is transparent.

12. A moulding apparatus for the production of an article made of moulded plastic material with a first component and at least one second component overmoulded on said first component, comprising: a mould and a countermould defining between them a moulding cavity; injection means for injecting within said cavity, respectively in a first and in a subsequent second injection step, the material of said first component and the material of said second component; and means for geometrical modification of said cavity following upon said first injection step, in which said second component has at least one of integral fixing elements and stiffening elements, said apparatus including a single station, defined by said mould and said countermould, for carrying out said first and second steps; said countermould having at least one recess for formation of said at least one of fixing elements and stiffening elements integral with said second component (2), and further including closing means for at least partial closing of said at least one recess prior to or during said first injection step.

13. The apparatus according to claim 12, wherein said closing means include mobile parts which can be displaced in said countermould between an advanced position for closing and a retracted position for opening said at least one recess.

14. The apparatus according to claim 12, wherein said closing means comprises a covering element configured to adhere to said first component and to be englobed within said second component.

15. The apparatus according to claim 12, wherein said covering means comprises a film.

16. The apparatus according to claim 12, wherein said covering means comprises an extractor means which can be displaced in said mould between an advanced position for closing and a retracted position for opening said recess.

17. The apparatus according to claim 12, wherein said means for modifying the cavity following upon said first step include the mould itself, which can be moved away from said countermould.

18. The apparatus according to claim 12, wherein said means for modifying the cavity following upon said first step include at least one mobile part of said countermould.

19. The apparatus according to claim 12, further including means for carrying out a compression step combined with at least one of said first and second injection steps.

20. The apparatus according to claim 12, further including means for carrying out a step of expansion and subsequent compression associated to at least one of said first and second injection steps.
